(19) United States
(12) Patent Application Publication
(10) Pub. No.: US 2012/0227548 A1
(43) Pub. Date: Sep. 13, 2012

(54) One-Way Wrench

(76) Inventor: Da-Sen LIN, (US)

(21) Appl. No.: 13/046,716

(22) Filed: Mar. 12, 2011

(51) Int. Cl. B25B 17/00

(52) U.S. Cl. 81/57.22

(57) ABSTRACT

A one-way wrench includes a head, a wheel, a pawl, a spring-biased detent assembly, a handle, a grip, a shaft and a transmission unit. The wheel includes a rack extending thereon. The pawl is for engagement with the wheel. The spring-biased detent assembly pushes the pawl against the wheel. The handle is connected to the head. The grip is rotationally located on the handle. The shaft is rotationally inserted through the handle and includes a first end fit in the grip and a second end located outside the handle. The transmission unit includes a first gear connected to the second end of the shaft, a second gear engaged with the first gear, a third gear engaged with the second gear, and a fourth gear connected to the third gear on one hand and engaged with the rack of the wheel on the other hand.

### BACKGROUND OF INVENTION

1. Field of Invention

The present invention relates to a one-way wrench and, more particularly, to a one-way wrench for providing two operative mode.

2. Related Prior Art

A typical selective one-way wrench includes a head, a handle extending from the head, and a selective one-way driving unit located in the head. The one-way driving unit includes a tongue extending from a side of the head and a switch located on an opposite side of the head. In use the tongue is fit in a cavity defined in a socket. By operating the switch, a clockwise or counterclockwise direction is selected to be an active direction. The handle is operable to pivot the head in the active direction so that the tongue drives the socket. The handle is operable to pivot the head in a neutral direction opposite to the active direction so that the tongue leaves the head un-pivoted. The operation of the typical selective one-way wrench is however not without problems.

At first, the operation wastes a lot of time. The handle made with an adequate length is essential for providing an adequate torque only in an initial phase of a loosening task or a final phase of a tightening task. It however takes much time to pivot the lengthy handle during the rest of the tightening or loosening task.

Secondly, the operation is inconvenient. As mentioned above, the handle made with an adequate length is essential for providing an adequate torque only in the initial phase of the loosening task or the final phase of the tightening task. The lengthy handle seems clumsy particularly in a limited working space during the rest of the tightening or loosening task.

Thirdly, the operation is unsteady in the initial phase of the tightening task or the final phase of the loosening task. This is because the nut or screw is too loose to provide an adequate resistance against the selective one-way wrench in the initial phase of the tightening task or the final phase of the loosening task.

The present invention is therefore intended to obviate or at least alleviate the problems encountered in prior art.

### SUMMARY OF INVENTION

It is the primary objective of the present invention to provide a one-way wrench operable in a first mode for exerting a large torque and a second mode for providing fast, convenient and steady spinning of a nut or screw.

To achieve the foregoing objectives, the one-way wrench includes a head, a wheel, a pawl, a spring-biased detent assembly, a handle, a grip, a shaft and a transmission unit. The wheel is located in the head and includes teeth formed thereon and a rack extending thereon. The pawl is located in the head and includes teeth for engagement with the teeth of the wheel. The spring-biased detent assembly is located in the head for pushing the pawl against the wheel. The handle is connected to the head. The grip is rotationally located on the handle. The shaft is rotationally inserted through the handle and includes a first end fit in the grip and a second end located outside the handle. The transmission unit includes a first gear connected to the second end of the shaft, a second gear engaged with the first gear, a third gear engaged with the second gear, and a fourth gear connected to the third gear on one hand and engaged with the rack of the wheel on the other hand.

Other objectives, advantages and features of the present invention will be apparent from the following description referring to the attached drawings.

### BRIEF DESCRIPTION OF DRAWINGS

The present invention will be described via detailed illustration of two embodiments referring to the drawings wherein:

FIG. 1 is an exploded view of a one-way wrench according to the first embodiment of the present invention;

FIG. 2 is an enlarged exploded partial view of the one-way wrench shown in FIG. 1;

FIG. 3 is a top view of the one-way wrench shown in FIG. 2;

FIG. 4 is a cross-sectional view of the one-way wrench shown in FIG. 1;

FIG. 5 is a perspective view of the one-way wrench shown in FIG. 1 in a first position;

FIG. 6 is a perspective view of the one-way wrench shown in FIG. 1 in a second position; and

FIG. 7 is a cross-sectional view of a one-way wrench according to the second embodiment of the present invention.

### DETAILED DESCRIPTION OF EMBODIMENTS

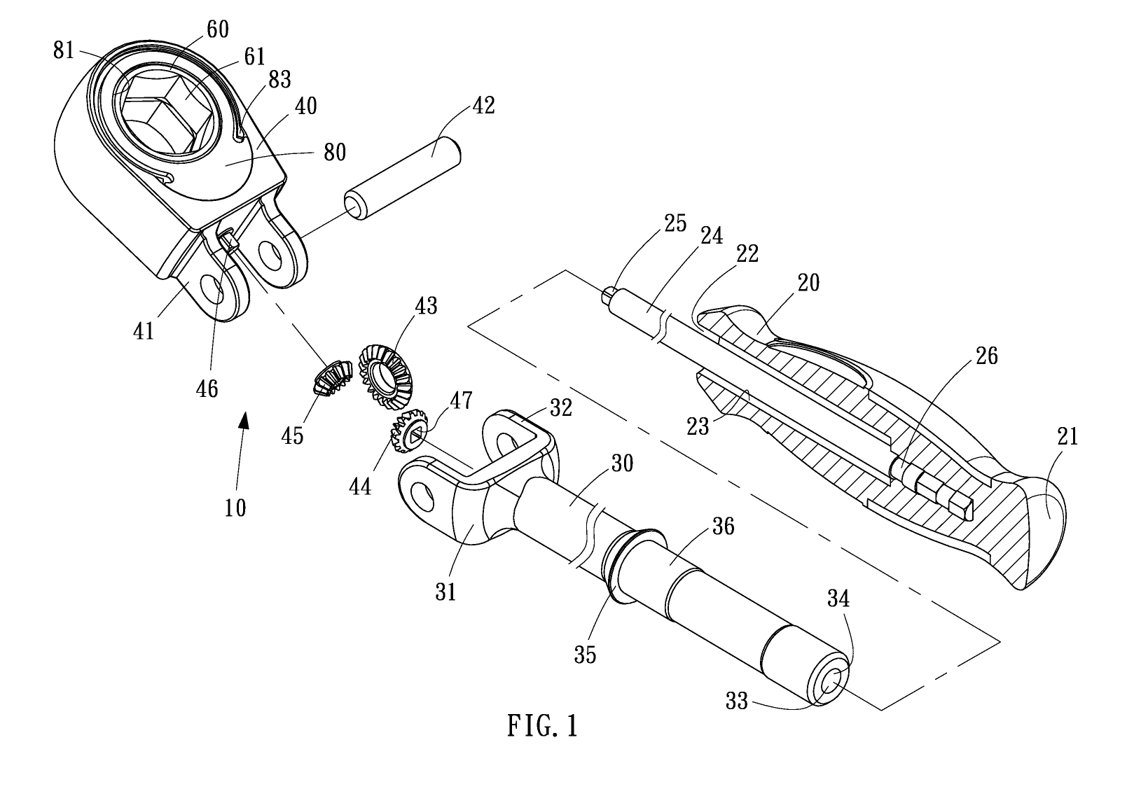

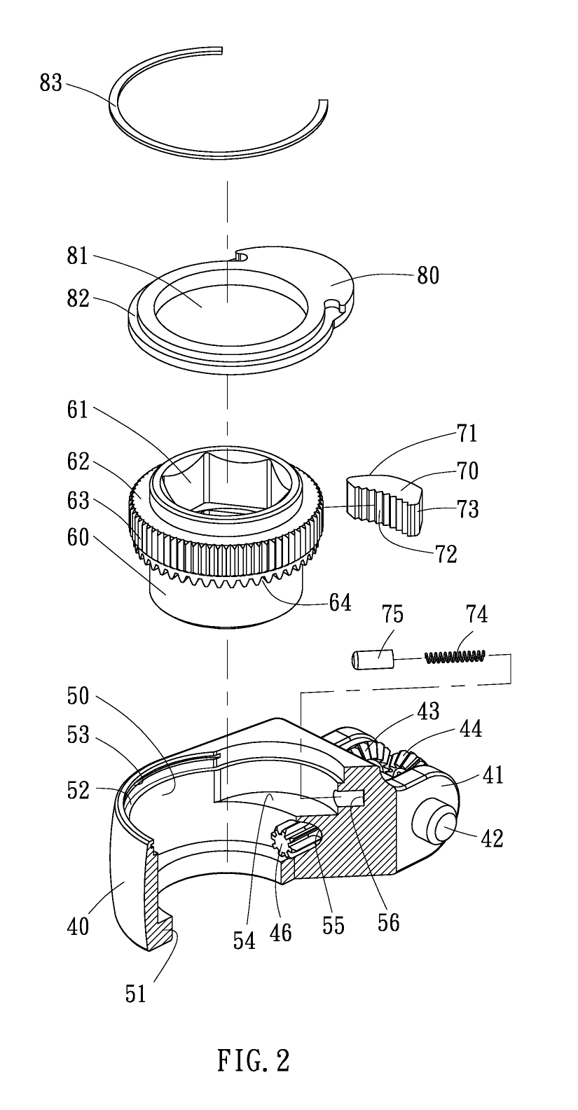

Referring to FIGS. 1 through 6, there is shown a one-way wrench 10 according to a first embodiment of the present invention. The one-way wrench 10 includes a head 40, a one-way driving unit located in the head 40, a handle 30 pivotally connected to the head 40, a transmission unit connected to the one-way driving unit, a shaft 24 connected to the transmission unit and inserted through the handle 30, and a grip 20 connected to the shaft 24 and located around the handle 30.

As clearly shown in FIG, 2, the head 40 includes two lugs 41 extending from an end thereof. The lugs 41 extend parallel to each other, with a gap defined between them.

The head 40 further includes a circular space 50, an annular flange 51, an 8-figured shoulder 52, an arched groove 53, a crescent cavity 54, a tunnel 55, and a recess 56. The circular space 50 includes an open end defined in a first side of the head 40 and another open end defined in an opposite second side of the head 40. The crescent cavity 54 includes an open end defined in the first side of the head 40 and a closed end opposite to the open end thereof. The crescent cavity 54 is in communication with the circular space 50 so that they together define an 8-figured space. The 8-figured shoulder 52 extends on and along the wall of the 8-figured space near the first side of the head 40. The arched groove 53 is defined in the wall of the circular space 50 above the 8-figured shoulder 52. The annular flange 51 extends on and along the wall of the circular space 50 near the second side of the head 40. The tunnel 55 extends from the crescent cavity 54 to the gap defined between the lugs 41. The recess 56 is in communication with the crescent cavity 54.

The one-way driving unit includes a wheel 60, a pawl 70, a spring-biased detent assembly, and a cover 80. The wheel 60 includes an engaging portion 61, an annular rib 62, teeth 63 and an annular rack 64. The engaging portion 61 of the wheel 60 is a non-circular space and, more particularly, a hexagonal space for receiving a hexagonal nut or a hexagonal head of a screw in the first embodiment. The engaging portion 61 of the wheel 60 may however be a non-circular and, more particularly, a square tongue for insertion in a square recess defined in a socket that receives a nut or a head of a screw.

The annular rib 62 extends on and around the wheel 60. The teeth 63 are formed on the periphery of the annular rib 62. Each of the teeth 63 extends in a radial direction from the annular rib 62. The annular rack 64 extends on a side of the annular rib 62. The annular rack 64 includes teeth each extending parallel to the axis of the wheel 60.

The pawl 70 includes an arched face 71 and teeth 72 formed on a face thereof opposite to the arched face 71. The arched face 71 includes a contact portion 73.

The spring-biased detent assembly includes a spring 74 and a detent 75. The spring 74 is preferably a helical spring. The detent 75 preferably includes a recess for receiving an end of the spring 74.

The cover 80 includes an annular portion 82 and a crescent portion. A circular opening 81 is defined in the annular portion 82 of the cover 80.

The transmission unit includes gears 43, 44, 45 and 46. The gears 43, 44 and 45 are bevel gears. The gear 43 includes a circular aperture defined therein. The gear 44 includes a square aperture 47 defined therein. The gear 45 includes a hexagonal aperture defined therein. The gear 46 is a spur gear including a hexagonal axle extending from a side thereof.

The handle 30 includes a fork 31, an insert 33, a tunnel 34 and an annular rib 35. The fork 31 extends from an end of the handle 30. The fork 31 includes two prongs 32 each including a circular aperture defined therein. The insert 33 extends from an opposite end of the handle 30. The tunnel 34 extends axially throughout the handle 30. The annular rib 35 extends on and around the handle 30.

The shaft 24 includes a non-circular and, more particularly, square end 25 and an opposite non-circular end 26. The non-circular end 26 of the shaft 24 preferably includes several sections of various profiles.

The grip 20 includes a closed end 21, an opposite open end 22 and a cavity 23 extending from the open end 22 to the closed end 21.

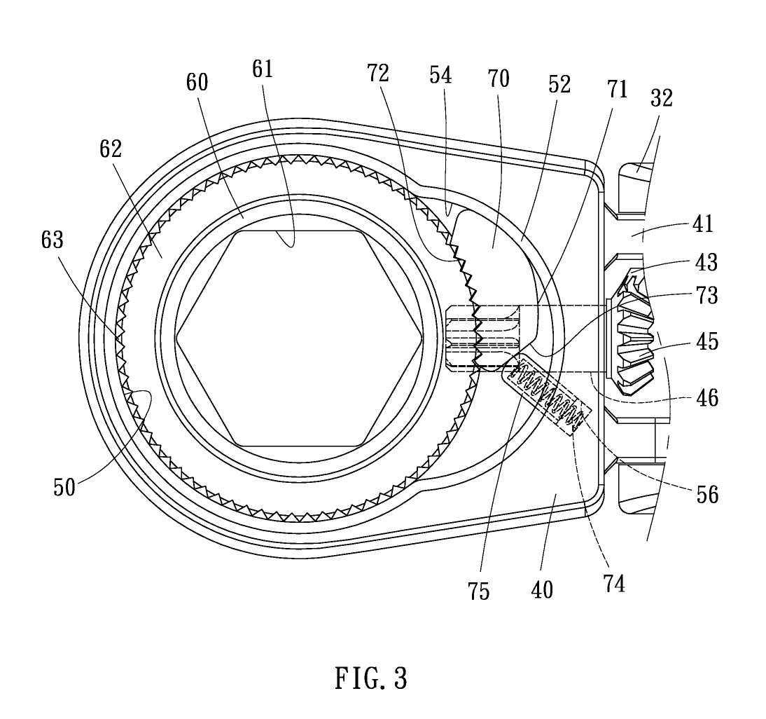

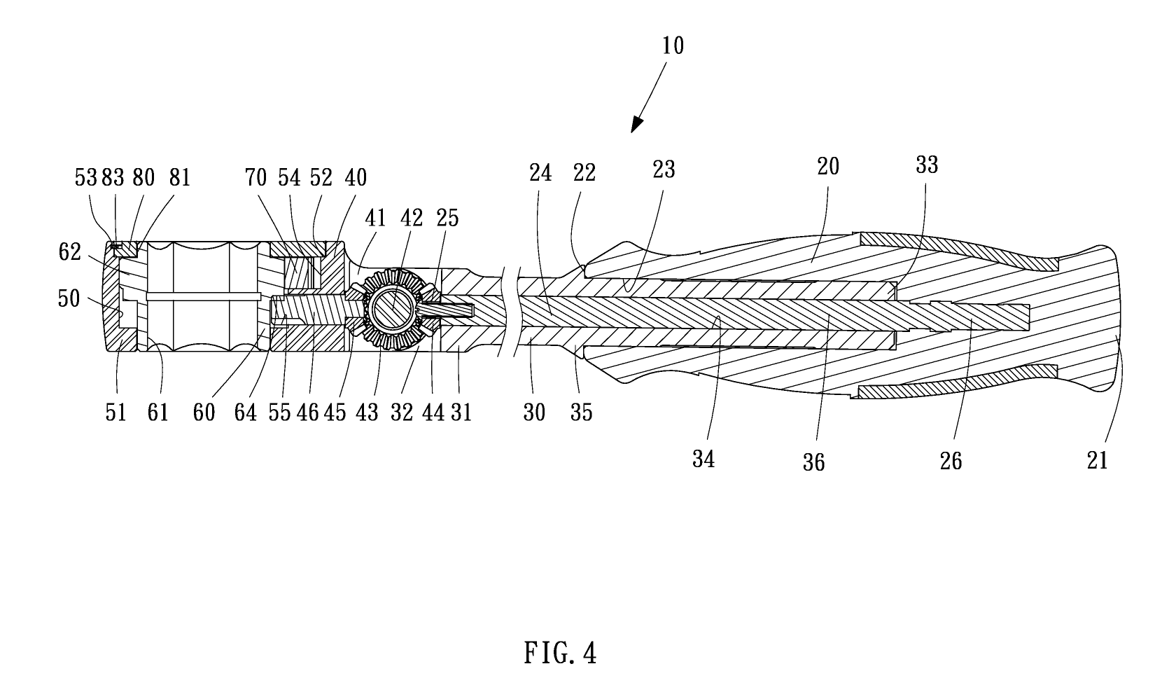

Referring to FIGS. 3 and 4, in assembly, the spring 74 is located in the recess 56 defined in the head 40. An end of the detent 75 is in contact with the spring 74 located in the recess 56 while an opposite end of the detent 75 is located in the crescent cavity 54.

The pawl 70 is located in the crescent cavity 54. The contact portion 73 of the arched face 71 of the pawl 70 is in contact with the detent 75. Thus, the pawl 70 is biased by the spring-biased detent assembly.

The wheel 60 is located in the circular space 50. Some of the teeth 63 formed on the wheel 60 are engaged with the teeth 72 formed on the pawl 70.

The cover 80 is supported on the 8-figured shoulder 52 formed on the head 40. The annular portion 82 of the cover 80 is located above the annular rib 62 of the wheel 60. The crescent portion of the cover 80 is located above the pawl 70. A C-clip 83 is located in the arched groove 53 defined in the head 40. Thus, the spring-biased detent assembly, the pawl 70 and the wheel 60 are kept in the head 40.

The gear 46 is inserted in the circular space 50 through the tunnel 55. The gear 46 is engaged with the annular rack 64 formed on the wheel 60. A free end of the hexagonal axle of the gear 46 is fit in the hexagonal aperture defined in the gear 45 so that the gears 46 and 45 spin together.

The closed end 21 of the grip 20 is formed on and around the non-circular end 26 of the shaft 24 so that the grip 20 and the shaft 24 spin together. The non-circular end 25 of the shaft 24 is located outside the cavity 23 defined in the grip 20.

The insert 33 of the handle 30 is inserted in the cavity 23 defined in the grip 20 while the shaft 24 is partially inserted in the tunnel 34 defined in the handle 30. The grip 21 and the shaft 24 are allowed to spin relative to the handle 30. The annular rib 35 is located against the grip 20 near the open end 22.

The square end 25 of the shaft 24 is fit in the square aperture 47 defined in the gear 44 so that the shaft 24 and the gear 44 spin together.

The gear 43 is engaged with the gears 44 and 45 before a pin 42 is inserted in the circular aperture defined in the gear 43, the circular apertures defined in the lugs 41 of the head 40, and the circular apertures defined in the prongs 32 of the fork 31 extending from the handle 30. Because of the pin 42, the transmission unit is assembled. Because of the pin 42, the handle 30 is pivotally connected to the head 40.

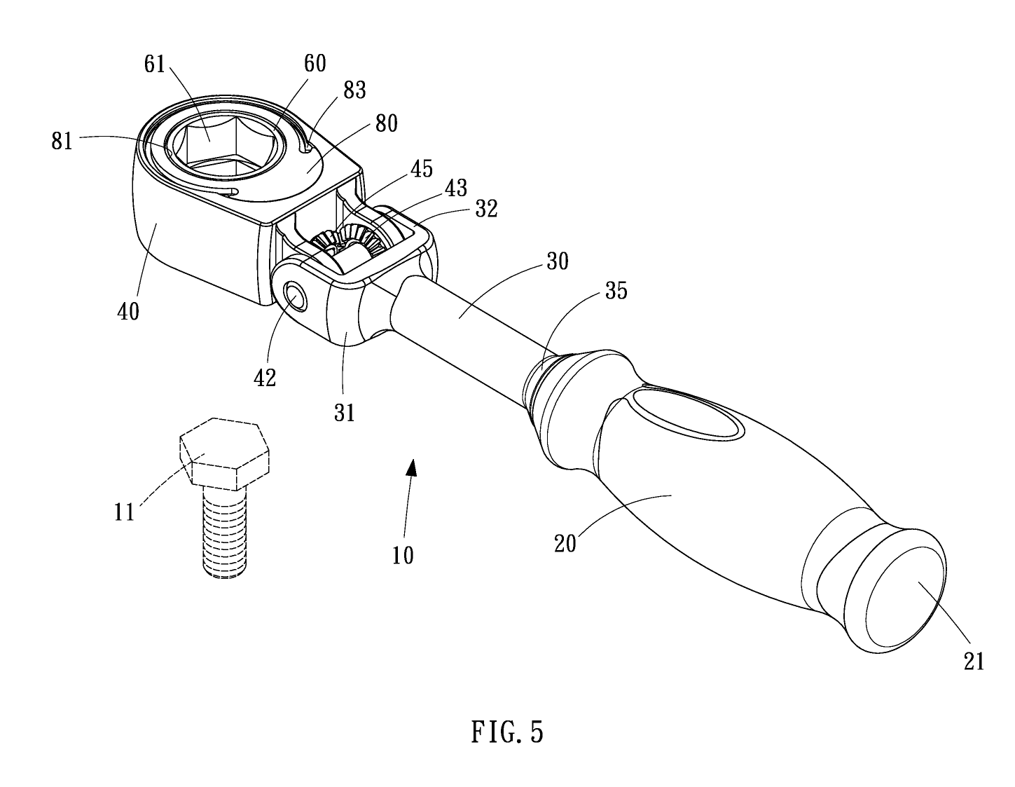

Referring to FIG. 5, the one-way wrench 10 is located in a first position and used to tighten a screw 11. In an initial phase of a task for tightening the screw 11, speed for spinning the screw 11 is the primary concern. The grip 21 is spun around the handle 30. Thus, the shaft 24 spins the wheel 60 through the transmission unit. The wheel 60 spins and tightens the screw 11.

In a final phase of the tightening task, adequate torque is the primary concern. The grip 21 and therefore the handle 30 are pivoted about the head 40 in an active direction for a distance. Thus, the head 40 pivots the wheel 60 through the pawl 70. The wheel 60 spins and tightens the screw 11. Then, the grip 21 and therefore the handle 30 are pivoted about the head 40 in an opposite neutral direction for a distance. The head 40 does not pivot the wheel 60 as the pawl 70 rattles on and moves along the wheel 60. Hence, the wheel 60 does not loosen the screw 11. The pivotal of the grip 21 and the handle 30 about the head 40 alternately in the active and neutral directions is repeated for several times to adequately tighten the screw 11.

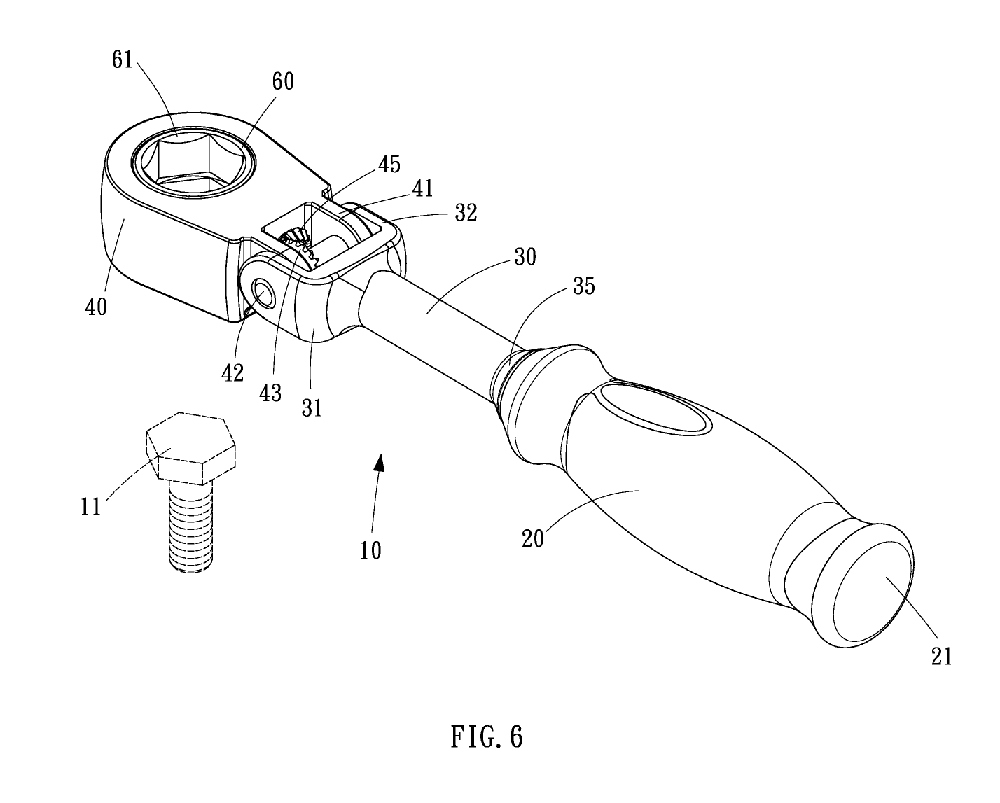

Referring to FIG. 6, the one-way wrench 10 is located in a second position and used to loosen the screw 11. In an initial phase of a task for loosening the screw 11, adequate torque is the primary concern. The grip 21 and therefore the handle 30 are pivoted about the head 40 in the active direction for a distance. Thus, the head 40 pivots the wheel 60 through the pawl 70. The wheel 60 spins and loosens the screw 11. Then, the grip 21 and therefore the handle 30 are pivoted about the head 40 in the neutral direction for a distance. The head 40 does not pivot the wheel 60 as the pawl 70 rattles on and moves along the wheel 60. Hence, the wheel 60 does not tighten the screw 11. The pivotal of the grip 21 and the handle 30 about the head 40 alternately in the active and neutral directions is repeated for several times to loosen the screw 11.

In a final phase of the loosening task, speed for spinning the screw 11 is the primary concern. The grip 21 is spun around the handle 30. Thus, the shaft 24 spins the wheel 60 through the transmission unit. The wheel 60 spins and loosens the screw 11.

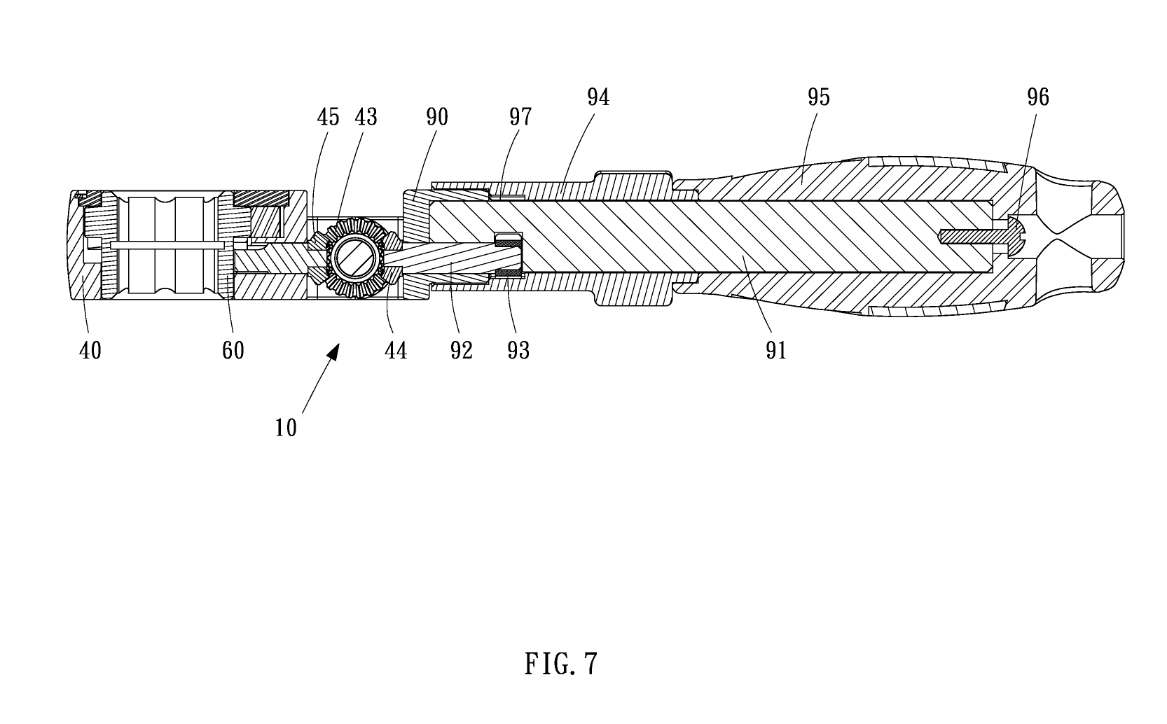

Referring to FIG. 7, there is shown a one-way wrench 10 according to a second embodiment of the present invention. The second embodiment is like the first embodiment except several things. At first, a fork 90 is used instead of the fork 31. The fork 90 includes a cavity defined therein. Secondly, a handle 91 is used instead of the handle 30. An end of the handle 91 is fit in the cavity defined in the fork 90 instead of the handle 30 formed together with the fork 31. The handle 91 includes a cavity defined therein near the end fit in the cavity defined in the fork 91. Thirdly, a shaft 92 is used instead of the shaft 24. The shaft 92 is located in the cavity defined in the handle 91 and inserted through an aperture defined in the fork 90. An end of the shaft 92 is fit in the square aperture 47 defined in the gear 44. Fourthly, there is provided a gear 93. An opposite end of the shaft 92 is fit in a square aperture defined in a gear 93. Fifthly, a sleeve 94 is rotationally provided on the handle 91. The sleeve 94 includes a toothed face 97 engaged with the gear 93. Thus, by spinning the sleeve 94 around the handle 91, the toothed face 97 spins the gear 93. The gear 93 spins the shaft 92. The shaft 92 spins the wheel 60 through the transmission unit. Sixthly, a grip 95 is used instead of the grip 20. The grip 95 is located on the handle 91 so that the grip 95 cannot spin around the handle 91. The grip 95 is connected to the handle 91 by a screw 96.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A one-way wrench including:
a head;
a wheel located in the head, wherein the wheel includes teeth formed thereon and a rack extending thereon;
a pawl located in the head and formed with teeth for engagement with the teeth of the wheel;
a spring-biased detent assembly located in the head for pushing the pawl against the wheel;
a handle connected to the head;
a grip rotationally located on the handle;
a shaft rotationally inserted through the handle, wherein the shaft includes a first end fit in the grip and a second end located outside the handle; and
a transmission unit including a first gear connected to the second end of the shaft, a second gear engaged with the first gear, a third gear engaged with the second gear, and a fourth gear connected to the third gear on one hand and engaged with the rack of the wheel on the other hand.

2. The one-way wrench according to claim 1, further including a pin, wherein the head includes two lugs formed thereon, wherein the handle includes a fork with two prongs, wherein the pin is inserted in the lugs and the prongs.

3. The one-way wrench according to claim 2, wherein the second gear is rotationally supported on the pin.

4. The one-way wrench according to claim 1, wherein the first gear includes a non-circular aperture defined therein, wherein the second end of the shaft is a non-circular end fit in the non-circular aperture defined in the first gear.

5. The one-way wrench according to claim 1, wherein the third gear includes a non-circular aperture for receiving a non-circular axle extending from the fourth gear.

6. The one-way wrench according to claim 1, wherein the first, second and third gears are bevel gears.

7. The one-way wrench according to claim 1, wherein the grip includes a cavity defined therein for containing the handle.

8. The one-way wrench according to claim 7, wherein the handle includes an insert inserted in the cavity defined in the grip.

9. The one-way wrench according to claim 8, wherein the handle includes an annular rib formed thereon and located against the grip.

10. The one-way wrench according to claim 1, wherein the handle includes a tunnel defined therein for containing the shaft.

11. A one-way wrench including:
a head;
a wheel located in the head, wherein the wheel includes teeth formed on the periphery and a rack extending on a side;
a pawl located in the head and formed with teeth for engagement with the teeth of the wheel;
a spring-biased detent assembly located in the head for pushing the pawl against the wheel;
a handle connected to the head;
a grip connected to the handle;
a shaft rotationally connected to the handle;
a sleeve rotationally located on the handle and operatively connected to the shaft;
a transmission unit including a first gear connected to the shaft, a second gear engaged with the first gear, a third gear engaged with the second gear, and a fourth gear connected to the third gear on one hand and engaged with the rack of the wheel on the other hand.

12. The one-way wrench according to claim 11, further including a fifth gear connected to the shaft, wherein the sleeve includes a toothed face engaged with the fifth gear.

13. The one-way wrench according to claim 11, further including a pin and a fork, wherein the head includes two lugs formed thereon, wherein the handle is connected to the fork, wherein the fork includes two prongs, wherein the pin is inserted in the lugs and the prongs.

14. The one-way wrench according to claim 13, wherein the second gear is rotationally supported on the pin.

15. The one-way wrench according to claim 11, wherein the third gear includes a non-circular aperture for receiving a non-circular axle extending from the fourth gear.
